(19) United States
(12) Patent Application Publication
(10) Pub. No.: US 2026/0079385 A1
(43) Pub. Date: Mar. 19, 2026

(54) CAMERA HANDGRIP ASSEMBLY WITH REAR SIDE PALM SUPPORT AND INTEGRATED THUMB ANCHOR

(71) Applicant: Awesome By Design Limited, Chatham (CA)

(72) Inventor: Karan SIDHU, Chatham (CA)

(73) Assignee: Awesome By Design Limited, Chatham, ON (CA)

(21) Appl. No.: 19/328,331

(22) Filed: Sep. 15, 2025

Related U.S. Application Data
(60) Provisional application No. 63/696,080, filed on Sep. 18, 2024.

(51) Int. Cl. G03B 17/56

(52) U.S. Cl. CPC G03B 17/563; G03B 17/561; G03B 17/566

(57) ABSTRACT

The present disclosure relates to camera accessories, specifically ergonomic camera handgrips and a camera accessory mounting assembly. The camera handgrip assembly includes a base plate, a palm grip, and a thumb anchor. The base plate conforms to the camera's bottom, while the palm grip and thumb anchor extend upwardly from the base plate adjacent a back portion of the camera to one side of the camera allowing the palm of the hand to support the camera. The base plate has a recess cut out as a relief on its front and bottom walls that provide support for the pinky finger. Additionally, the camera accessory mounting assembly features an accessory mounting cavity with a dual bevel configuration, ensuring a secure fit for tripod accessories.

### CROSS REFERENCE TO RELATED APPLICATIONS

This application claims priority to and the benefit of U.S. Provisional Application No. 63/696,080, entitled “CAMERA ACCESSORIES” and filed Sep. 18, 2024, which is hereby incorporated by reference in its entirety for all purposes.

### TECHNICAL FIELD

The present disclosure relates generally to camera accessories, specifically to camera handgrips, and to a camera accessory mounting assembly, that provide ergonomic comfort while maintaining full camera functionality.

### BACKGROUND

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

In the past, traditional cameras featured prismatic, simplistic designs characterized by squared and straight edges. These geometric forms were primarily a result of the basic manufacturing techniques available at the time, which limited design complexity. While these designs ensured durability and functionality, they lacked the ergonomic considerations needed for comfortable, extended use.

With the advancement of manufacturing technologies, camera manufacturers gained the ability to introduce ergonomic contours into camera bodies. These improvements made cameras more comfortable to hold, enhancing usability for photographers. However, despite these advancements, modern camera design faces new challenges.

As technology has progressed, camera bodies have continued to shrink in size, offering portability and compactness. However, lens design has not followed this trend, as optical requirements still dictate the size and weight of lenses. This creates an imbalance between the small, lightweight camera bodies and the larger, heavier lenses. Furthermore, while manufacturers are capable of incorporating ergonomic improvements, they often do not prioritize grip design because no two hands are alike. In the world of mass production, where efficiency is key, it is not always feasible to design grips that suit every individual's needs, leading to standardized grips that may not provide optimal comfort for all users.

To address the shortcomings of camera ergonomics, third-party grip manufacturers offer solutions to improve handling. However, most current designs focus on supporting the fingers on the lens side of the camera, which results in adding bulk to the front of the grip. This decision leads to larger grips that are intended to accommodate bigger hands but in turn add weight to the camera, detracting from both its portability and aesthetics. This approach fails to solve the one-size-fits-all problem inherent in camera design, as the grips become cumbersome and do not suit all users.

Consequently, photographers are often forced to purchase an additional accessory, a thumb grip, to improve handling and control. However, thumb grips introduce their own set of challenges.

Thumb grips are separate accessories that are installed in the cold shoe or hot shoe of the camera, typically located in the middle-top portion of the body. While they can provide better stability and ergonomics when used with a front grip, they block access to the camera's hot shoe, which is configured for mounting accessories such as external flashes, electronic viewfinders, microphones, and LED lights. By occupying the hot shoe, thumb grips prevent photographers from using these accessories, further complicating their setup.

There remains a need for a streamlined, ergonomic solution that provides a secure grip for the user's hand without obstructing the camera's functionality or occupying accessory mounting points.

### BRIEF SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

The present disclosure relates generally to camera accessories, specifically to camera handgrips, and to a camera accessory mounting assembly, that provide ergonomic comfort while maintaining full camera functionality.

In one aspect the present disclosure provides a camera handgrip assembly comprising a base plate, a palm grip with thumb anchor. The base plate conforms to the camera's bottom, while the palm grip with thumb anchor extend upwardly from the base plate adjacent a back portion of the camera to one side of the camera allowing the palm of the hand to support the camera.

In another aspect the present disclosure provides a camera handgrip assembly comprising a base plate that has a recess cut out as a relief on its front and bottom walls that provide support for a finger.

In another aspect the present disclosure provides a camera accessory mounting assembly having an accessory mounting cavity where a base plate has opposing tapering walls with a mounting cavity recessed in each wall.

In accordance with one aspect of the disclosure there is provided a camera handgrip assembly comprising a base plate, a palm grip with thumb anchor. The base plate has a shape that conforms with a bottom portion of a camera. The base plate is configured to be removably affixed with the bottom portion of the camera. The palm grip extends upwardly from the base plate and configured to be positioned adjacent a back portion of the camera towards one side of the camera when the base plate is affixed to the camera allowing access to user interface components of the camera and providing a palm supporting surface. The thumb anchor is configured to project above the palm grip and outwardly of the back portion of the camera to anchor a thumb for enhancing stability and control of the camera.

In accordance with another aspect of the disclosure there is provided a camera handgrip comprising a base plate configured to be removably affixed to a bottom portion of a camera. The base plate has an ergonomic recess located in front of the base plate, wherein the ergonomic recess is configured to receive and locate a portion of a finger against the recess, and the recess having rounded edges providing a smooth finger supporting surface.

In accordance with another aspect of the disclosure there is provided a camera accessory mounting assembly comprising base plate and a mounting cavity. The base plate is configured to be removably affixed to a bottom portion of a camera. The base plate has a front wall and a back wall, each of the front wall and back wall having a top wall portion and a bottom wall portion where the bottom wall portion is tapered outwardly in relation to the top wall portion and the bottom wall portion is thicker than the top wall portion. The mounting cavity is recessed in each of the front and the back walls comprising a dual bevel configuration with a bottom surface and a top surface sloping towards each other and inwardly of the corresponding front or back wall.

In another aspect, the present disclosure provides a camera handgrip assembly wherein the palm grip with thumb anchor are integrally formed as a unit and are hinged at their lower portion to the base plate. The hinge feature enables the palm grip with thumb anchor assembly to pivot outwardly from its position adjacent to the rear surface of the camera, thereby facilitating access to camera features that may otherwise be obstructed by the palm grip with thumb anchor.

### BRIEF DESCRIPTION OF THE SEVERAL VIEWS OF THE DRAWINGS

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

FIGS. 1A to 1F illustrate different views of an aspect of the subject matter in accordance with one embodiment for the camera handgrip assembly and camera;

FIGS. 2A to 2F illustrate different views of an aspect of the subject matter in accordance with one embodiment for the camera handgrip assembly;

FIGS. 3A to 3D illustrate different views of an aspect of the subject matter in accordance with one embodiment for the camera handgrip assembly and camera;

FIGS. 4A to 4G illustrate different views of an aspect of the subject matter in accordance with one embodiment for the camera handgrip assembly;

FIGS. 5A to 5F illustrate different views of an aspect of the subject matter in accordance with one embodiment for the camera handgrip assembly;

FIGS. 6A to 6D illustrate different views of an aspect of the subject matter in accordance with one embodiment for the camera accessory mounting assembly;

FIGS. 7A to 7F illustrate various additional views of an aspect of the subject matter in accordance with one embodiment for the camera handgrip assembly;

FIG. 8 illustrates a plan view of an embodiment of the base plate of the camera handgrip assembly;

FIG. 9 illustrates a perspective view of palm grip with thumb anchor of an embodiment of the camera handgrip assembly;

FIGS. 10A to 10F illustrate views and an aspect of the subject matter in accordance with one embodiment for the camera handgrip assembly;

FIGS. 11A and 11B illustrate exploded assembly views in accordance with one embodiment for the camera handgrip assembly;

FIG. 12 illustrates hand features in accordance with embodiments for the camera handgrip assembly.

### DETAILED DESCRIPTION

The present disclosure relates generally to camera accessories, specifically to camera handgrips, and to a camera accessory mounting assembly, that provide ergonomic comfort while maintaining full camera functionality.

In accordance with an aspect, a camera handgrip assembly configured to enhance the ergonomic comfort and stability of camera handling. This assembly comprises a base plate, a palm grip with thumb anchor, where the palm grip with thumb anchor is located adjacent a rear or back portion of the camera to one side of the camera.

The base plate of the camera handgrip assembly is shaped to conform with the bottom portion of a camera. It is configured to be securely affixed to the camera's bottom, ensuring a stable foundation for the assembly. The base plate is affixed with the camera body, providing a smooth and unobtrusive interface.

As used herein, the term “base plate” refers to a structural component of the camera handgrip assembly configured to be affixed to a bottom portion of a camera. In an embodiment, the base plate may comprise a continuous outer upstanding wall that at least partially surrounds the bottom portion of the camera, an inner wall or ledge extending inwardly from the upstanding wall, and a cross member extending between lateral portions of the inner wall or ledge. The bottom wall of the camera may be supported by the ledge and the cross member snugly within the upstanding wall. In one embodiment, the cross member includes openings and may incorporate a post or projection configured to fit into a corresponding recess or aperture in the bottom of the camera should the camera have one, as well as a fastener, such as a screw, passing through the cross member to engage a threaded hole in the camera bottom wall, for example, a tripod mount. This arrangement provides secure attachment and precise positioning of the base plate relative to the camera with the base plate releasably affixed to the camera.

Alternatively, the base plate may be configured to be affixed to the camera using other quick clamping methods known in the art, such as, for example, ball lock pins, cam locks, quarter-turn latches etc. These alternative affixing mechanisms may be selected based on the specific camera model, user preference, or intended application. The base plate may be formed as a single, integral piece and may include additional features such as mounting cavities, ergonomic recesses, or locating pockets, as described herein.

As used herein, “palm grip” refers to a structure configured to ergonomically support the palm of a user's hand when the palm grip is positioned adjacent to the rear side of the camera, particularly supporting the thenar eminence, to enhance comfort and stability during camera use.

The palm grip extends upwardly from the base plate. The palm grip is positioned adjacent to the back portion of the camera, towards one side. In most embodiments, the palm grip is positioned towards the right side of the camera when viewed from the rear, corresponding to the conventional location of the shutter button on the right side of the camera. However, in the event a camera is developed with the shutter button on the left side, the palm grip may be positioned towards the left side of the camera. The present disclosure is intended to cover both configurations. This strategic placement of the palm grip relative to the camera and attachment to the base plate allows users to maintain access to the camera's user interface components, such as buttons and dials, on the rear surface of the camera while providing a comfortable surface for the palm. In particular, the palm grip is ergonomically shaped to support the thenar eminence, the fleshy, muscular portion of the palm at the base of the thumb, thereby reducing hand fatigue and discomfort during prolonged use. The palm grip is positioned to engage the thenar eminence of the user's hand, offering a secure and comfortable grip on the camera body. Unlike traditional camera grips that often add bulk and weight, the present disclosure achieves a lightweight and streamlined form, making it suitable for photographers with varying hand sizes.

As used herein, the term “thenar eminence” refers to the fleshy, rounded area at the base of the thumb on the palm side of the hand. This region is formed by a group of intrinsic muscles responsible for the thumb's fine motor movements, and plays a vital role in gripping, pinching, and manipulating objects. Ergonomic support of the thenar eminence enhances user comfort and control when holding the camera.

In one embodiment, the palm grip includes an integrated thumb anchor that projects above the palm grip and outwardly from the back portion of the camera. This thumb anchor is specifically configured to provide a secure anchoring point for the user's thumb, thereby enhancing the stability and control of the camera during use.

As used herein, “thumb anchor” refers to a structure configured to project above and outwardly from the palm grip, adjacent to the rear side of the camera, and to provide a secure anchoring point for the user's thumb to enhance stability and control during camera use.

By integrating the thumb anchor into the palm grip, the assembly provides ergonomic support for the thumb, reducing hand fatigue and improving handling, especially during prolonged use.

The thumb anchor is configured to project above the palm grip and outwardly of the back portion of the camera. This provides an anchor for the thumb, enhancing the stability and control of the camera. By integrating the thumb anchor into the palm grip either as an integral formation or an attachment, frees up the camera's hot shoe or cold shoe, allowing users to attach accessories such as flashes, microphones, or electronic viewfinders. It also eliminates the need for providing a front grip on the camera, making the use of a front grip an option for photographers with larger hands. In an embodiment, the thumb anchor is configured with opposing side portions that narrow the thumb anchor to a tip portion as it projects away from the back portion of the camera and wherein at least one of the opposing side portions has a concave curvature.

The present aspect offers several advantages over existing camera grips. Traditional handgrip designs primarily focus on supporting the fingers, adding bulk to the front of the camera, often near the lens side. While this may seem like a practical solution, it overlooks a key ergonomic fact: fingers are naturally dexterous and can easily conform to different shapes without the need for additional bulk. In contrast, the palm and thumb are less adaptable, and providing support for these areas is far more effective for improving overall grip and comfort.

In accordance with another aspect, a camera handgrip assembly is provided wherein the palm grip with thumb anchor that are integrally formed and are pivotally attached to the base plate by a hinge mechanism. The hinge is located at the lower portion of the palm grip arm and comprises a pin passing through corresponding openings in both the base plate and the lower portion of the palm grip arm, or may utilize alternative hinge mechanisms, such as, for example, a living hinge, a flexible joint, or other suitable pivoting structures, to enable pivotal movement of the palm grip with thumb anchor assembly relative to the base plate. This hinge aspect allows the palm grip with thumb anchor assembly to pivot outwardly, enabling the user to adjust the position of the grip to facilitate access to camera features that may otherwise be obstructed by the palm grip with thumb anchor. A key benefit of this configuration is that the palm grip with thumb anchor can be placed at an optimal ergonomic location for the user's hand, without concern for obstructing camera buttons. When access to camera buttons is required, such as for changing settings or reviewing images, the grip can be conveniently moved out of the way. In general, these buttons are not needed during picture taking as they are typically used for setup or playback. Additionally, as camera bodies become smaller and manufacturers pursue larger, articulating LCD screens, buttons are often positioned near the edge of the camera, where the user's hand naturally grips. This can result in unintentional button presses. The hinged palm grip with thumb anchor assembly addresses this issue by allowing the grip to be positioned in ideal location for gripping, which in some cameras is right where the user interface components e.g. buttons and dials are. Because the palm grip with thumb anchor acts like a shield between the user interface components and hand, thereby preventing accidental activation of camera controls while maintaining ergonomic comfort.

When the palm grip with thumb anchor assembly is in the closed position, the lower portion of the palm grip arm forms a continuous surface with the outer wall of the base plate, providing a seamless and unobtrusive interface. The palm grip with thumb anchor are further configured to follow the contour of the camera body and, in certain embodiments, may partially extend around the rear wall and side wall portions of the camera, thereby enhancing ergonomic support and stability. The thumb anchor projects above the palm grip in accordance with previous embodiments, providing an anchor for the thumb to enhance stability and control of the camera.

The hinge feature may be constructed using a metal pin, dowel, or similar fastener, and the openings in the base plate and palm grip arm may be sized to provide a snug, interference fit or may include bushings or bearings to facilitate smooth pivoting action. Alternatively, other hinge mechanisms may be employed, as appropriate for the intended application. The materials and manufacturing methods for the hinged palm grip with thumb anchor assembly may be selected from those described in other embodiments, including metal alloys, polymers, or additive manufacturing techniques.

By moving the support to the back of the camera, as provided for in the present disclosure, where the palm and thumb naturally rest, the present disclosure handgrip becomes lighter and more efficient. Supporting the palm, which is less dexterous than the fingers, creates a more stable and secure hold on the camera without adding unnecessary weight to the front of the camera. This also allows for a more minimalist configuration that doesn't interfere with the overall look or functionality of the camera. In many cases, the support for the palm and thumb can be made so discreet that handgrip of the present disclosure is almost hidden from view, maintaining the aesthetic appeal of the camera while offering substantial ergonomic benefits.

Moreover, this configuration of the present disclosure frees up the hot shoe for its intended use, ensuring that accessories like flashes or microphones can still be mounted without being obstructed by another gripping solution such as thumb grip. Additionally, with the present disclosure moving the support to the back, the need for a front grip becomes optional, and when used, the front grip can be significantly smaller and more streamlined than in traditional front grips as the front grip of the present disclosure no longer has to carry the main load of support.

By addressing the limitations of prior art and offering a practical, lightweight, and aesthetically pleasing solution, the present aspect represents a significant advancement in camera handgrip technology.

In accordance with another aspect, a camera handgrip assembly is disclosed comprising a base plate and an ergonomic recess located in front of the base plate for enhancing the ergonomic comfort and stability of camera handling.

The base plate of the camera handgrip assembly is configured to be securely affixed to the bottom portion of a camera. A feature of this base plate is the ergonomic recess located at the front. This recess is configured to receive and locate a portion of the pinky finger, providing a smooth and comfortable supporting surface. The rounded edges of the recess ensure that the pinky finger rests comfortably, reducing strain and enhancing the overall grip. Depending on a photographer's hand size and preference this recess may be used to receive a knuckle in the pinky finger or another finger.

The ergonomic recess comprises a relief cut in the base plate ensuring a smooth finger supporting surface. The recess features a curved and concave profile, which conforms to the natural shape of the finger, further enhancing comfort and stability. Additionally, the ergonomic recess extends partially onto the bottom surface of the base plate, providing a seamless transition and ensuring that the finger supports the camera even during dynamic camera movements.

Existing cameras and base plates often have sharp or rounded corners that do not allow a pinky finger to comfortably fit beneath the camera. This makes it cumbersome to hold all four fingers against the front of the camera, leading to discomfort and instability during use. In contrast, the ergonomic recess offers a streamlined and versatile solution that accommodates different hand sizes without compromising the camera's functionality. The ergonomic recess in the base plate provides a dedicated and comfortable resting place for the pinky finger, reducing hand fatigue and discomfort. This feature ensures that the camera remains comfortable to hold and use, even during extended photography sessions.

In accordance with another aspect, a camera accessory mounting assembly comprising a base plate having a mounting cavity is disclosed. The mounting cavity is configured with precision on the front and back walls of the base plate, and in this embodiment, tailored for use with Arca-Swiss style quick-clamping systems for tripod mounting. This mounting cavity allows the camera and grip mounting assembly to securely attach to dovetail-style quick-change systems, providing photographers with a reliable and efficient means of connecting their equipment to tripods. By including the mounting cavities in the base plate, the grip eliminates the purchase of separate quick-change plate.

The mounting cavity comprises a dual bevel system, which replaces the traditional dovetail approach. The bottom portion of the cavity resembles a dovetail, providing a secure connection, while the top portion is angled at 45 degrees in the opposite direction, creating a 90-degree junction between the two surfaces. This geometry not only ensures a secure and stable fit within the dovetail-style quick-change systems but also allows the cavity to be recessed or nested within the walls of the base plate. By nesting the dual bevel design inside the walls, the base plate maintains a sleek, smooth exterior for comfortable handheld use while offering a snug, dependable connection when mounted. Additionally, the dual bevel configuration for the mounting cavity provides ease of manufacturing, as it can be produced using standard end mills, eliminating the need for specialized tools like dovetail cutters. This design innovation results in a more cost-effective and efficient production process.

This nested configuration of the mounting cavity is made by the tapering of the base plate walls. The bottom portion of the walls is tapered outward in relation to the top, creating space to accommodate the dual bevel mounting cavity. This outward tapering allows the cavity to sit deeper within the base plate, enhancing both the security of the mounting system and the overall rigidity of the structure. This cavity is tailored for use with Arca-Swiss style quick-clamping systems for mounting on a tripod. By ensuring that the cavity is recessed into the base plate, the design balances form and function, providing a secure and quick mounting solution that remains smooth and unobtrusive during handheld use.

The tapered walls offer additional benefits beyond just accommodating the dual bevel design. By expanding the material at the bottom, the tapering provides additional structural support around areas of the base plate, particularly in cases where cutouts for battery or memory card access are located near the edges. The increased material at the bottom ensures that the walls remain strong and durable, even when these cutouts are in place, preventing the base plate from becoming too fragile or developing thin, weak points around these access areas. This combination of design choices results in a robust, long-lasting base plate that performs well under the rigors of regular use while maintaining a sleek, ergonomic profile.

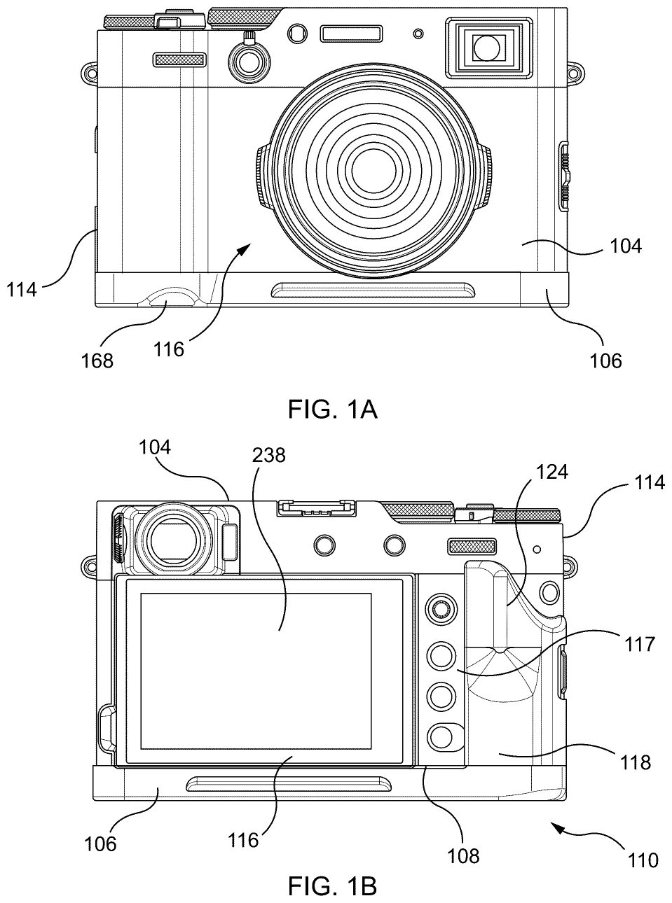

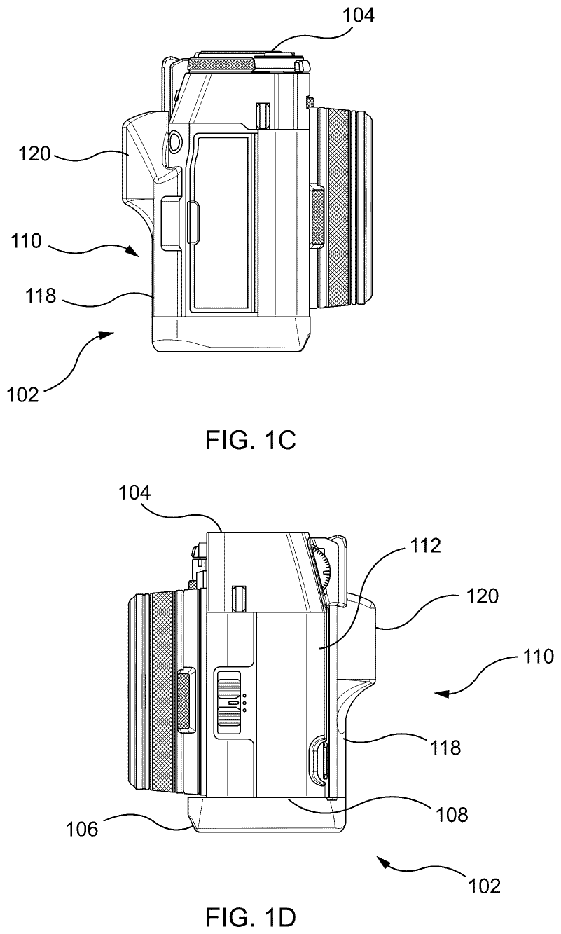

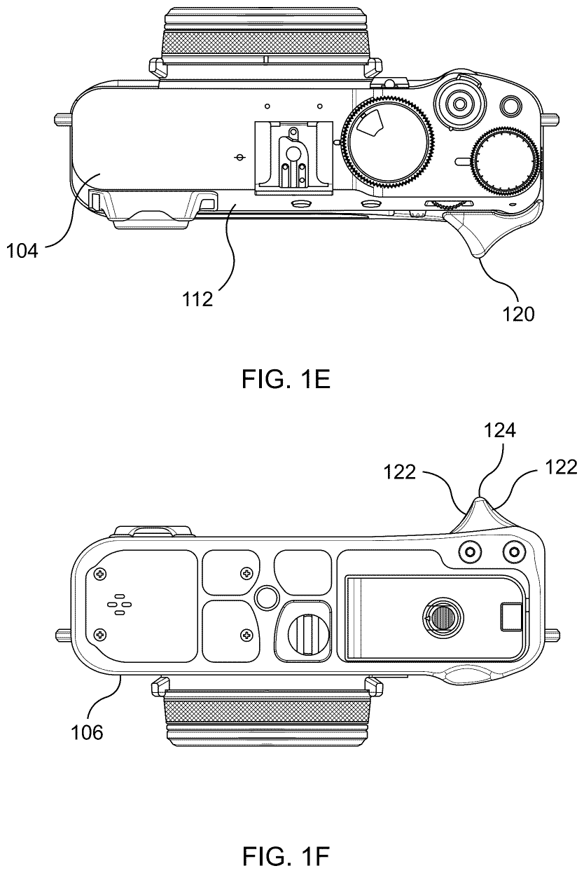

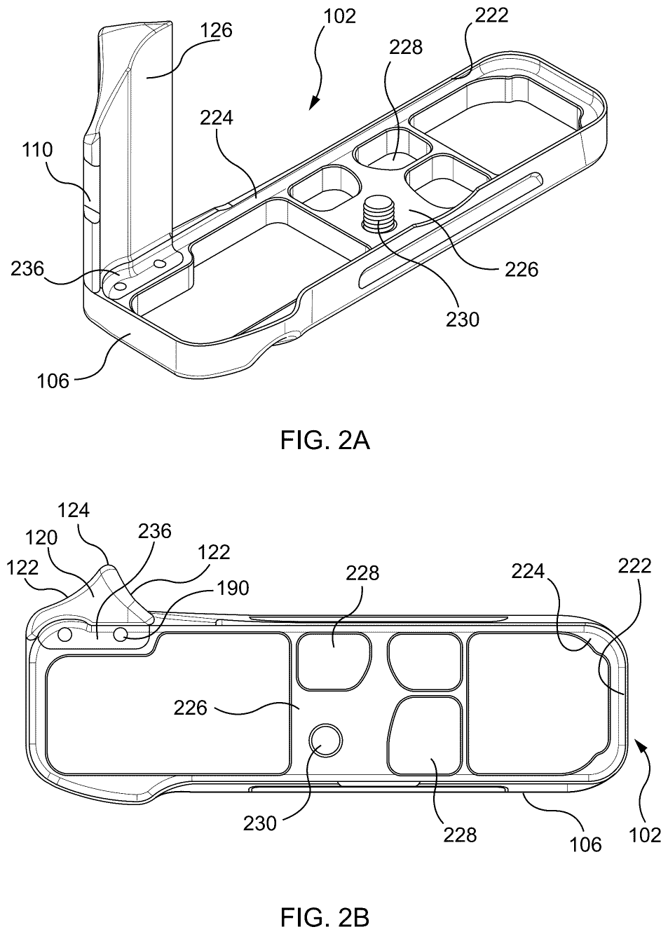

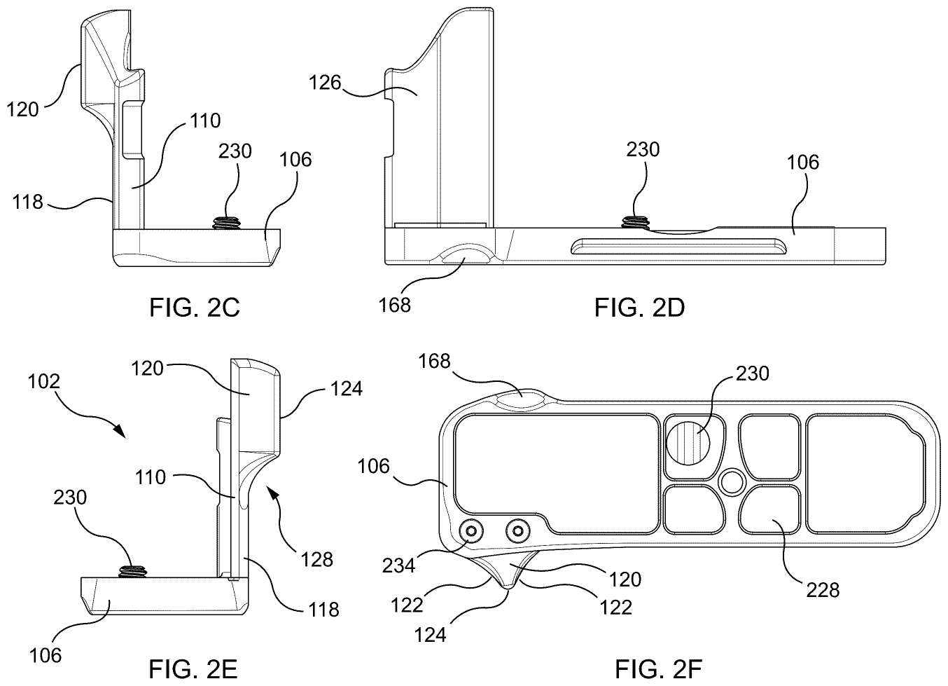

Referring to FIGS. 1A to 1F and FIGS. 2A to 2F an embodiment for the camera handgrip assembly 102 is shown. As illustrated in FIGS. 1A to 1F, different views are shown of the camera handgrip assembly 102 assembled with a camera 104, and in FIGS. 2A to 2F, which show various views of the camera handgrip assembly 102 itself.

The camera handgrip assembly 102 comprises a base plate 106 that conforms to the bottom portion of a camera 104. The base plate 106 is configured to be affixed to the bottom portion 108 of the camera 104. In this embodiment, a threaded fastener, such as, for example a screw, passes through the base plate 106, securely releasably affixing it to the bottom portion 116 of the camera 104. Alternative forms of mounting the base plate 106 to the camera 104 may comprise the use of quick clamping methods, for example, ball lock pins, cam lock, and quarter turn latches, or any other suitable quick-release or clamping mechanisms known in the art.

Referring now to FIGS. 2A to 2F, in an embodiment, the base plate 106 may comprise a continuous outer upstanding wall 222 that at least partially surrounds the bottom portion 108 of the camera 104. An inner wall or ledge 224 extends inwardly from the upstanding wall 222, providing a supporting surface for the camera bottom. A cross member 226 extends between lateral portions of the inner wall or ledge 224, further reinforcing the structure of the base plate 106. The bottom wall of the camera 104 may be supported by both the ledge 224 and the cross member 226, allowing the camera to be snugly received within the upstanding wall 222. In one embodiment, the cross member 226 includes one or more openings 228. Additionally, a fastener, such as a screw 230, may pass through the cross member 226 to engage a threaded hole in the camera bottom wall, for example, a tripod mount. This arrangement provides secure attachment and precise positioning of the base plate 106 relative to the camera 104, with the base plate 106 being releasably affixed to the camera.

Extending upwardly from the base plate 106 is a palm grip 110, which is positioned adjacent to the back portion 112 of the camera 104 towards one side 114 of the camera 104 when the base plate 106 is affixed to the camera 104. This configuration allows access to the user interface components 117 of the camera 104 such as, for example, buttons and dials, while providing a palm supporting surface 118. The palm grip 110 features a smooth, ergonomic palm supporting surface 118 for supporting the thenar eminence of the palm when holding the camera, thereby reducing hand fatigue and discomfort during prolonged use.

Additionally, the camera 104 handgrip assembly 102 includes a thumb anchor 120 that projects above the palm grip 110 and outwardly from the back portion 112 of the camera 104. This thumb anchor 120 enhances the stability and control of the camera 104 by providing an anchor for the thumb. The thumb anchor 120 in this embodiment is integrally formed with the palm grip 110 and is configured with opposing curved side portions 122, generally concave, and that narrow into a tip portion 124 as the thumb anchor 120 projects away from the back portion 112 of the camera 104. Alternatively, the thumb anchor 120 may be detachably attached to the palm grip 110. Of the two side portions 122 of the thumb anchor, it should be understood that the main thumb support surface is the side portion 122 adjacent to the LCD screen 238 of the camara, that is the side portion 122 facing the middle of the camera. The other side portion 122 facing away from the middle of the camera has a curvature that is a configuration choice providing a balanced look.

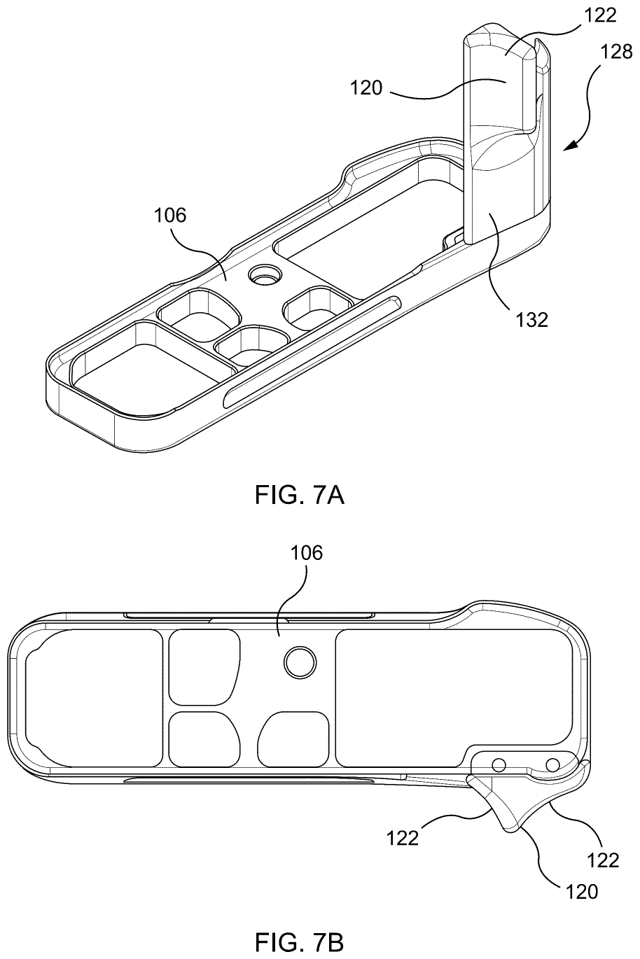

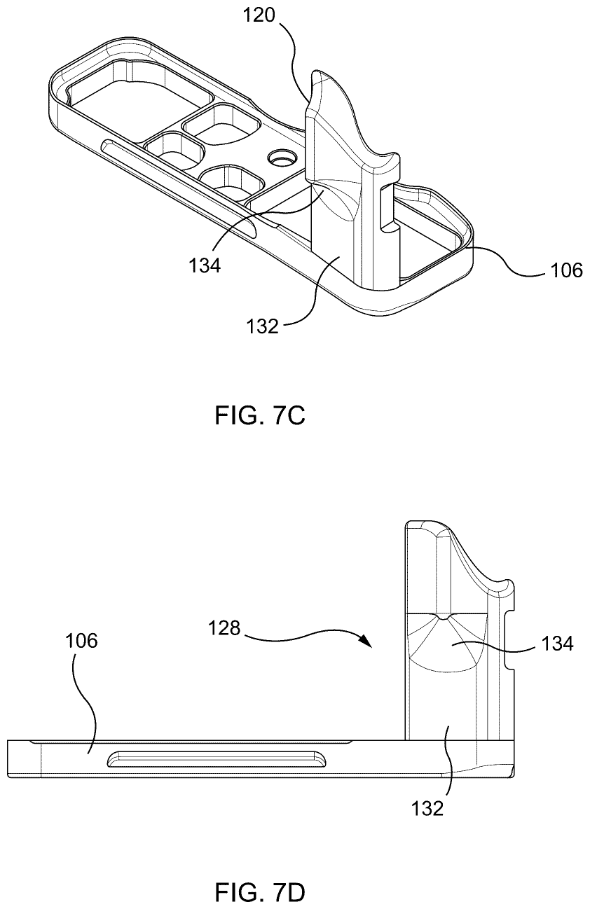

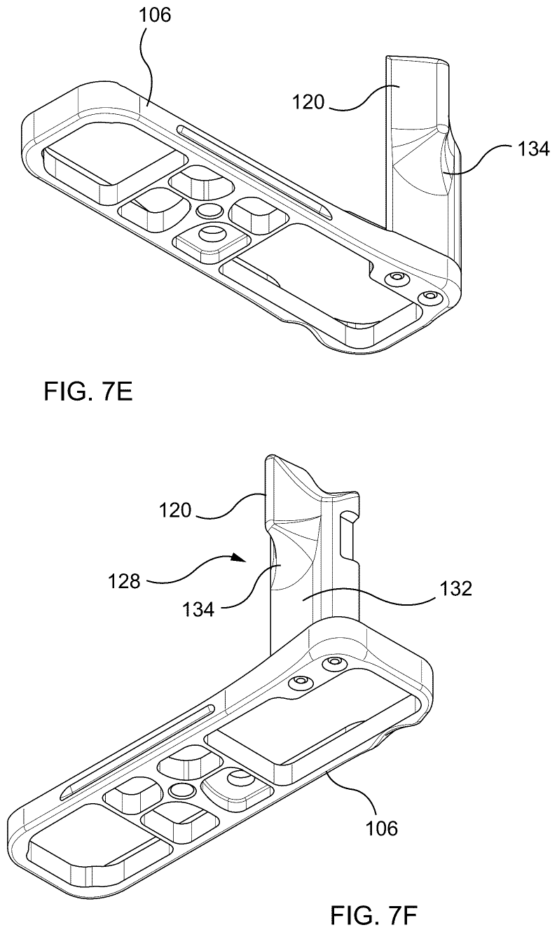

The palm grip 110 and thumb anchor 120 share both inner and outer profile 126, 128. The inner profile 126 partially surrounds the back portion 112 and one side 114 of the camera 104, conforming to the shape of the camera 104 to ensure a secure and manageable fit. The secure and manageable fitting relation is generally intended to allow unobstructed access to the camera's features and functions; however, in certain embodiments, some features may be partially obstructed without significantly impairing the overall usability of the camera. The outer profile 128 (see FIG. 7A) features a smooth, curving lower portion 132 against which the palm of the hand may grip or rest upon. This lower portion 132 has a flush, continuous profile with the base plate 106, providing a smooth interface, without sharp edges, between the base plate 106 and the lower portion 132 of the palm grip 110. The outer profile 128 of the palm grip 110 above the lower portion 132, middle portion 134, curves outwardly relative to the back portion 112 of the camera 104, transitioning into the thumb anchor 120.

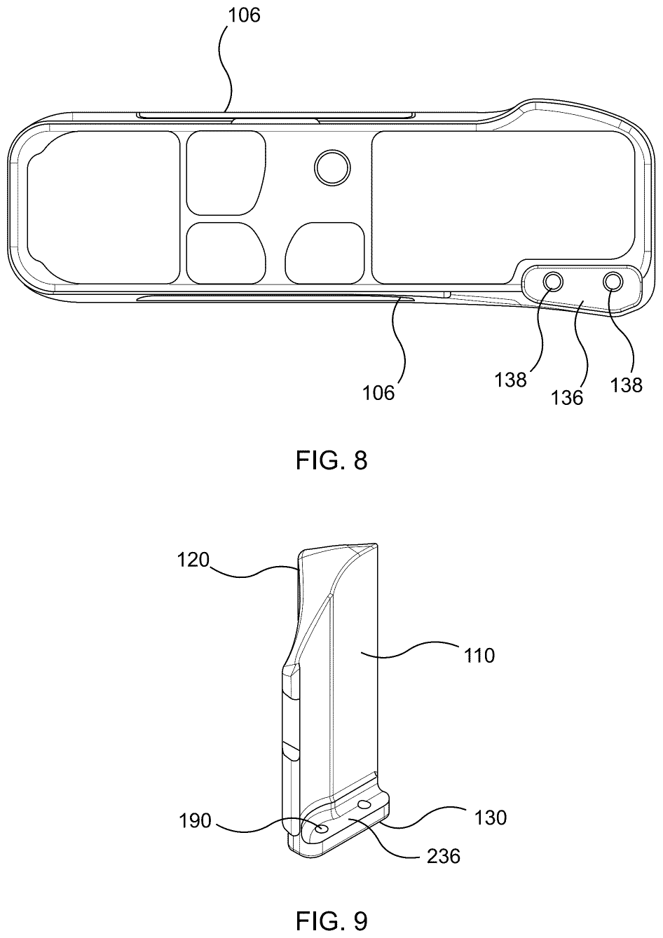

Also referring to FIGS. 2A, 2B, 2C and 2F, as well as FIGS. 8 and 9, the base plate 106 of the camera handgrip assembly 102 comprises a first locating pocket 136 with holes 138 passing through it. As used herein, the term “locating pocket” is also commonly referred to as a “land.” As shown in FIGS. 2A, 2B, 2C and 2F, screws 234 pass through these holes 138 in the base plate 106. The lower or bottom portion 130 of the palm grip 110 abuts and is seated in this first locating pocket 136 with the upper surface 236 of the bottom portion 130 being flush with the ledge 224 of the base plate 106. The bottom portion 130 of the palm grip further includes recessed threaded holes 190 that align with the holes 138 in the base plate. Threaded fastener, such as, for example, screws 234, pass through these holes 138 in the base plate 106, thereby securing the palm grip 110 to the base plate 106. Alternatively, a peg, or metal dowel, may be used in place of one of the screws where the corresponding bore is not threaded. As a further alternative, the first locating pocket 136 of the base plate 106 may comprise a seating well into which a bottom post like portion 130 of the palm grip 110 is inserted in a mating relation therewith by a press fit, interference fit or snug fit. Additionally, the palm grip 110 may be permanently assembled to the base plate 106 by gluing, welding, or brazing.

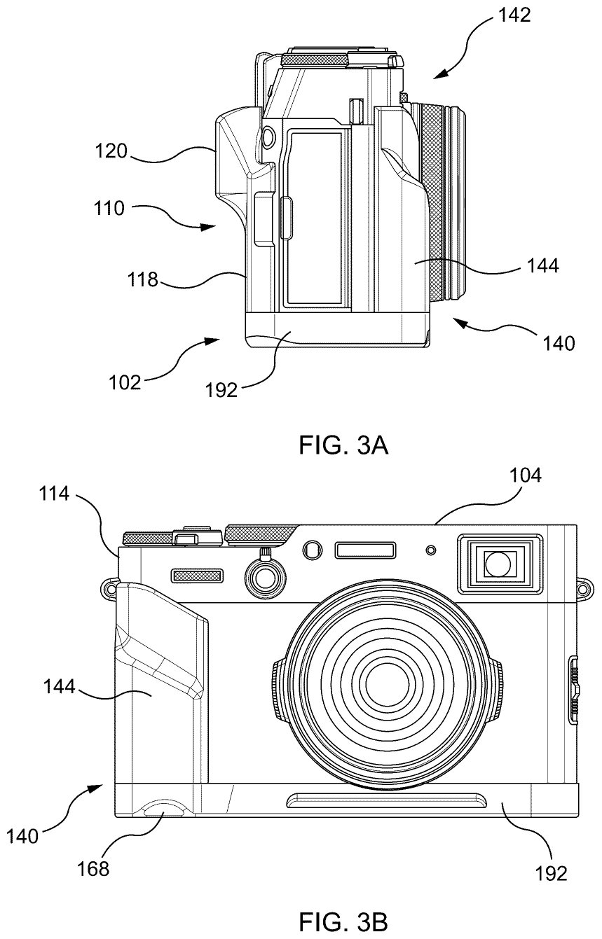

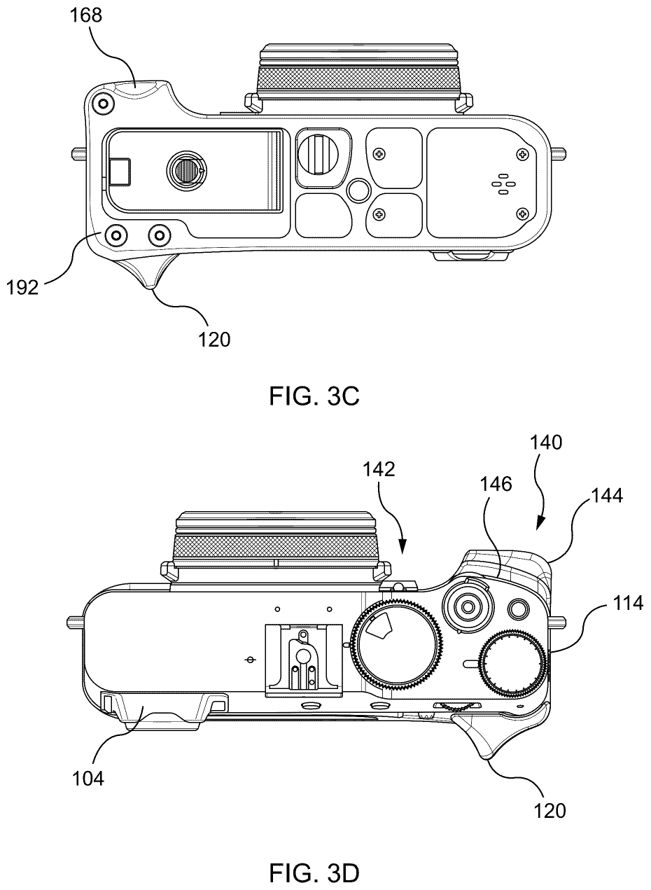

As illustrated in FIGS. 3A to 3D, the camera handgrip assembly 102 further comprises a front grip 140 extending upwardly from the base plate 192. Base plate 192 differs from base plate 106 in an aspect where base plate 192 is configured to support the front grip 140 in addition to the palm grip 110. It should be understood that the configuration of a base plate changes for each camera the base plate is customized to fit with.

Front grip 140 is an optional add-on feature that may be added to the base plate 192 in addition to the palm grip 110 to accommodate for larger hands. The front grip 140 is configured to be positioned adjacent to a front portion 142 of the camera 104 towards one side 114 of the camera 104, i.e. the same one side as the location of the palm grip 110, when the base plate 192 is affixed to the camera 104, providing a finger supporting surface 144. The front grip 140 has a front grip inner profile 146 and a front grip outer profile 148. The front grip inner profile 146 partially surrounds the front portion 142 and one side 130 of the camera 104, conforming to the shape of the camera 104 so that the front grip 140 partially surrounds the camera 104 in a secure and manageable fitting relation. The front grip outer profile 148 has a smooth convex curvature for supporting fingers, with a lower portion 150 of the front grip 140 located flush and continuous with the base plate 192.

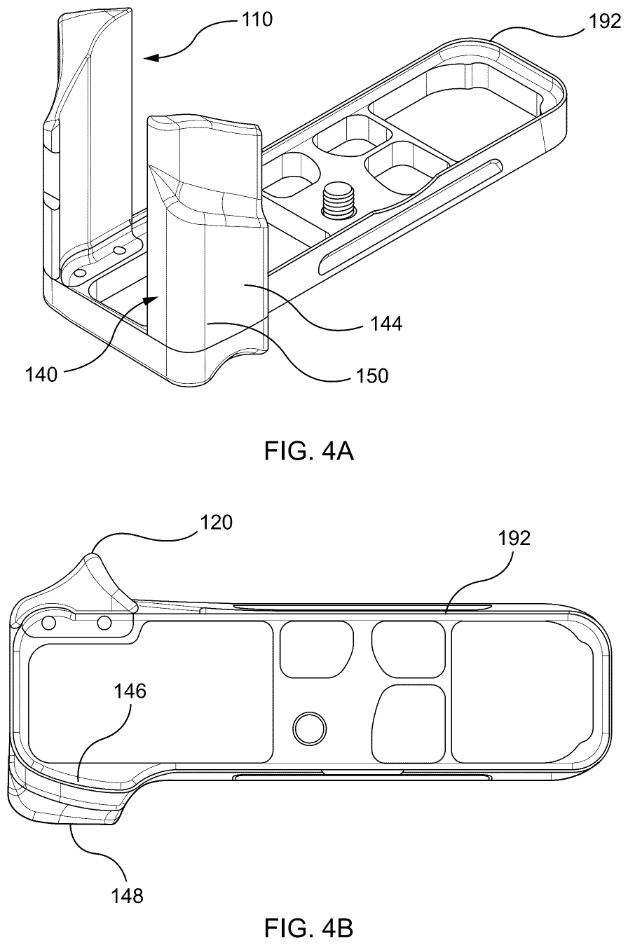

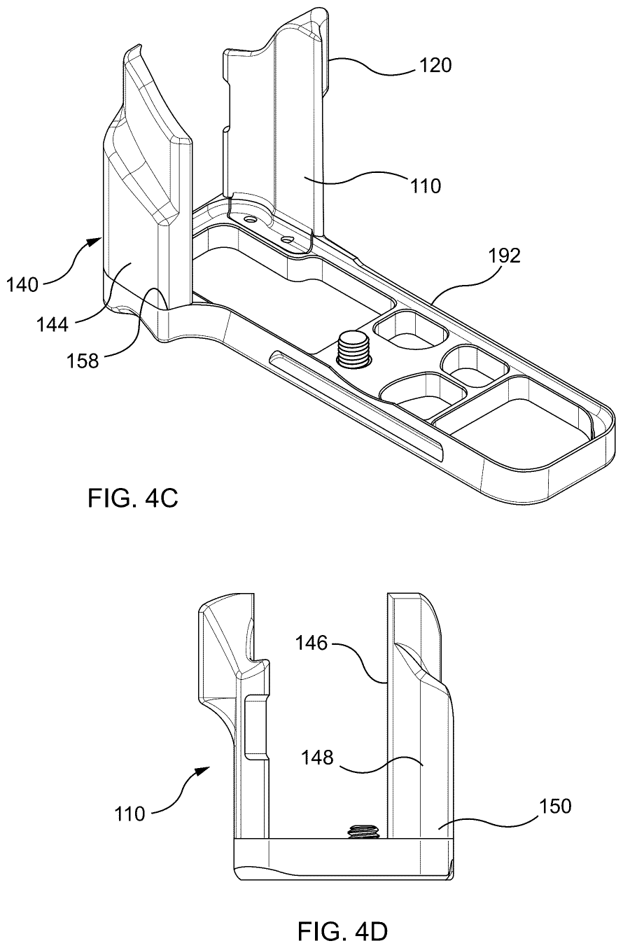

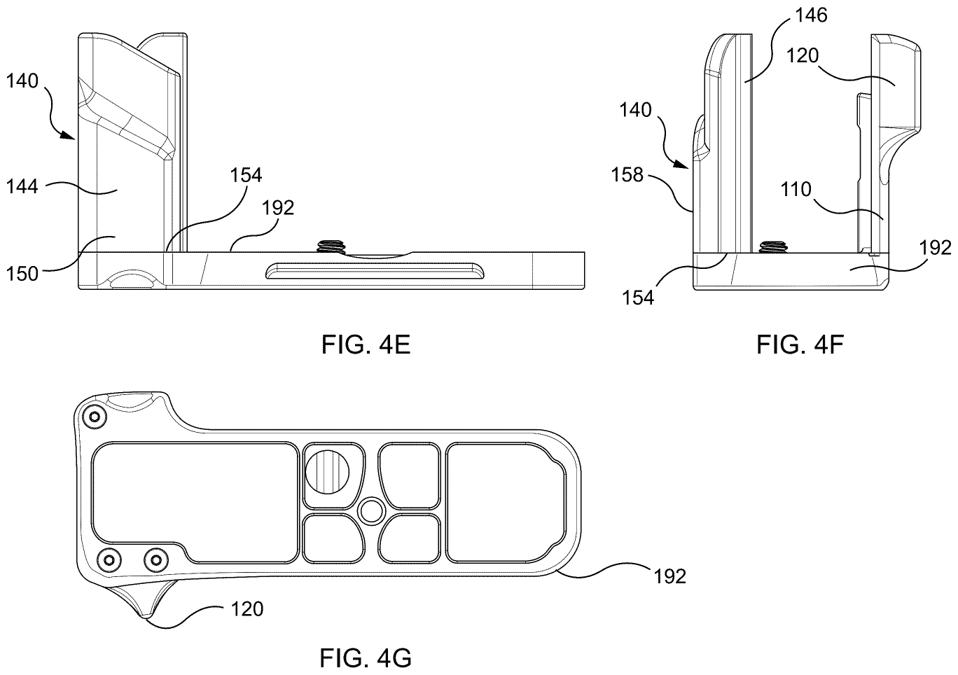

As illustrated in FIGS. 4A to 4G, the base plate 192 comprises a second recessed pocket or land 154 with second holes passing through it (similar in configuration to the land or first locating pocket 136. The front grip 140 has a front grip bottom portion 158 that abuts the land 154, with at least one second recessed threaded apertures or bores extending into the front grip 140 bottom portion 158 that align with the second holes passing through the land 154. Corresponding threaded screws may pass through the second holes and are screwed into the second holes of the front grip bottom portion 158, securing the front grip 140 to the base plate 192. In an embodiment, one of the apertures or bores is not threaded and is adapted to receive a peg, or metal dowel, that also rests in a non-threaded receiving bore in the base plate 192. Like the palm grip 110, the front grip 140 bottom portion 158 may be of reduced dimension for seating in another well of the base plate 192. Additionally, the front grip 140 may be permanently assembled to the base plate 192 by gluing, welding, or brazing.

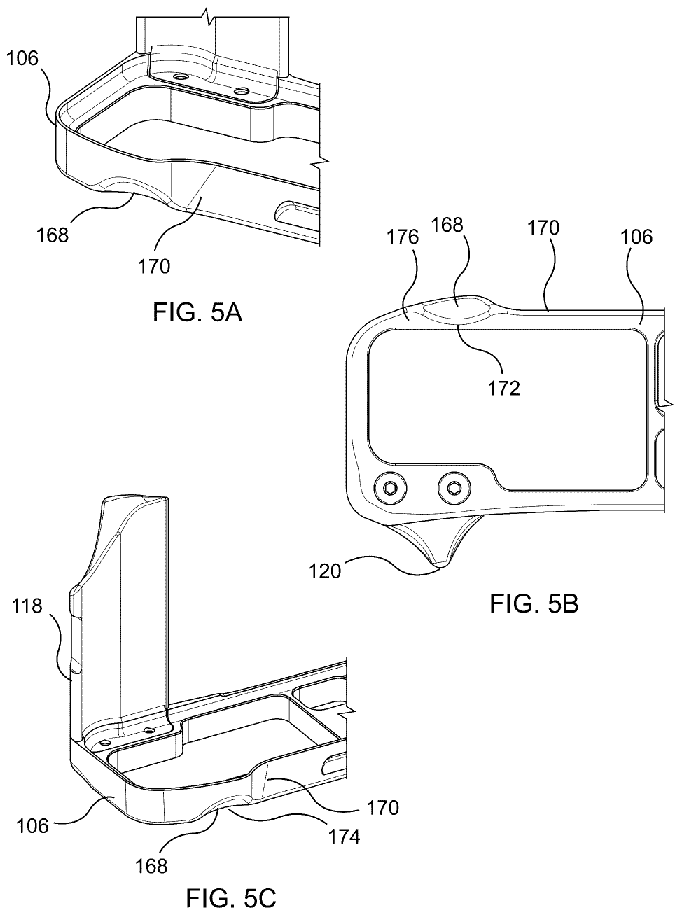

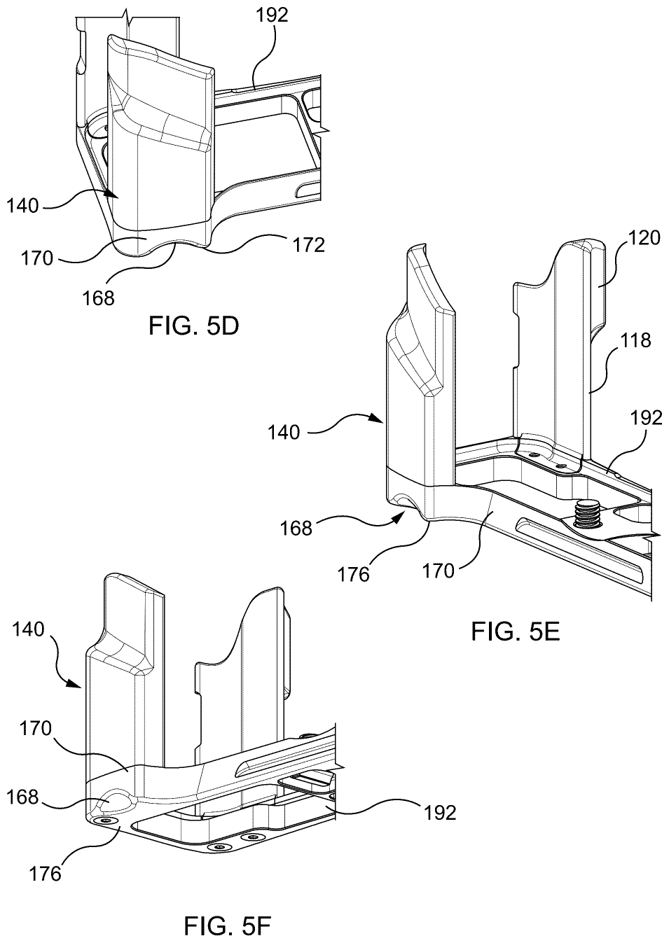

Referring to the drawings of FIGS. 5A to 5F, various views of an embodiment of the camera handgrip assembly 102 are illustrated. FIGS. 5A to 5C illustrate the base plate and back palm grip only. FIGS. 5D to 5E illustrate the base plate with the back palm grip and front finger grip. The camera handgrip assembly 102 comprises the base plate 106 in FIGS. 5A to 5C and the base plate 192 in FIGS. 5D to 5F, both configured to be affixed to the bottom portion 108 of a camera 104. The base plate 106 and 192 features an ergonomic recess 168 located on the front surface or wall 170 of the base plate 106, 192. This ergonomic recess 168 is configured to receive and locate a portion of a pinky finger against the recess 168, providing a comfortable and supportive surface for the pinky finger. The recess 168 is characterized by its rounded edges 172, which ensure a smooth and pleasant finger-supporting surface. It should be understood that depending on hand size and photographer preference this recess 168 may support other fingers of the photographer. The ergonomic recess 168 has a curved and concave profile, enhancing the comfort and support provided to the user's finger.

Furthermore, as illustrated in FIGS. 5A to 5F, the ergonomic recess 168 is located on the front surface 170 of the base plate 106 and 192 and extends partially onto the bottom surface 176 of the base plate 106, 192. This ensures that the finger is comfortably supported relative to both on the front and bottom surfaces of the base plate 106 or 192, providing a secure and ergonomic grip for the user.

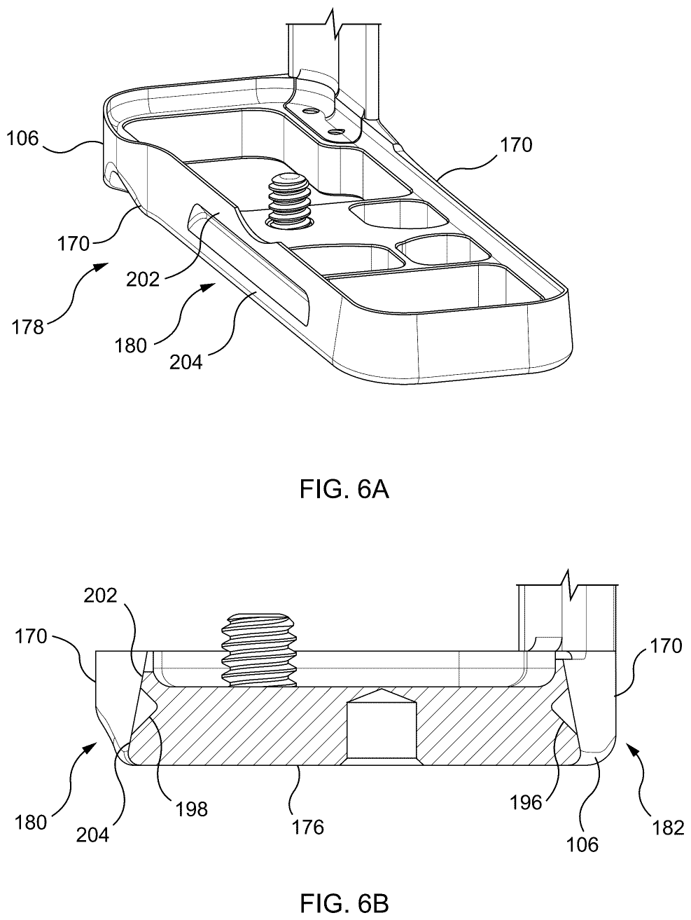

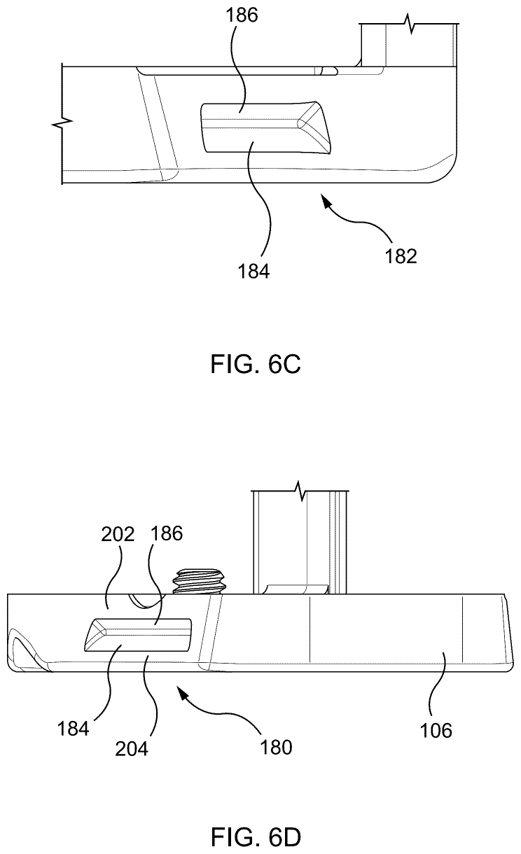

Referring to the drawings of FIGS. 6A to 6D, various full and partial views of an embodiment of quick mounting feature 178 of the handgrip assembly 102 is illustrated. The quick mounting feature 178 comprises a base plate 106 configured to be affixed to a bottom portion of a camera 104. The base plate 106 includes front and back exterior walls 170 and a cavity 180 that inwardly protrudes into each of the front and back exterior walls 170 into the base plate 106.

In the embodiment shown, the mounting cavities 180 and 182 are configured with precision on both the front and back exterior walls 170 respectively, of the base plate 106. These mounting cavities 180 and 182 on opposing sides allows the camera, when attached to the base plate, to in-turn be securely attached to dovetail-style, also knows as Arca Swiss style, quick-change systems, providing photographers with a reliable and efficient means of connecting their equipment to tripods. By including the mounting cavities 180 and 182 in the base plate, the grip eliminates the purchase of separate quick-change plate.

Sloping surfaces 184 and 186 of cavity 182 are perpendicular to each other and comprise a dual bevel configuration 196 in cavity 182 on the back side wall. Similarly, a dual bevel configuration 198 is formed in cavity 180 on the front side wall. The sloping surfaces 184 of the two dual bevels 196 and 198 are at 45 degrees to the bottom surface 176 of the base plate 106 but in opposing directions which in turn, make a dovetail, which replaces the traditional dovetail design that tends to protrude outwards from the side walls. This geometry not only ensures a secure and stable fit within the dovetail-style quick-change systems but also allows the cavity to be recessed or nested within the walls of the base plate. By nesting the dual bevel configuration 196 and 198 inside the walls 170, the base plate 106 maintains a sleek, smooth exterior for comfortable handheld use while offering a snug, dependable connection when mounted.

Additionally, the dual bevel configurations 196 and 198 in the mounting cavities 180 and 182 provide ease of manufacturing, as it can be produced using standard end mills, eliminating the need for specialized tools like dovetail cutters. This configuration results in a more cost-effective and efficient production process. The nested configuration of the mounting cavity 180 is made by the tapering of the base plate walls 170. From FIG. 6D, the bottom wall portion 204 of the wall 170 is tapered outward in relation to the top wall portion 202 of wall 170, creating space to accommodate the dual bevel mounting cavity 180. This outward tapering allows the cavity to sit deeper within the base plate 106, enhancing both the security of the mounting system and the overall rigidity of the structure. In effect, the walls 170 of the base plate are configured with the bottom wall portion 204 being thicker than the top wall portion 202.

The outward taper also ensures that the external surface of the base plate 106 remains smooth and unobtrusive, enhancing the grip's ergonomics for handheld shooting. By ensuring that the cavity 180 and cavity 182 are recessed into the base plate 106, the configuration balances form and function, providing a secure mounting solution that doesn't interfere with the user experience during handheld use. This outward tapering also offers additional benefits beyond just accommodating the dual bevel configuration. By expanding the material at the bottom, the tapering provides additional structural support around areas of the base plate, particularly in cases where cutouts for battery or memory card access are located near the edges. The increased material at the bottom ensures that the walls remain strong and durable, even when these cutouts are in place, preventing the base plate 106 from becoming too fragile or developing thin, weak points around these access areas. This combination of configuration choices results in a robust, long-lasting base plate that performs well under the rigors of regular use while maintaining a sleek, ergonomic profile.

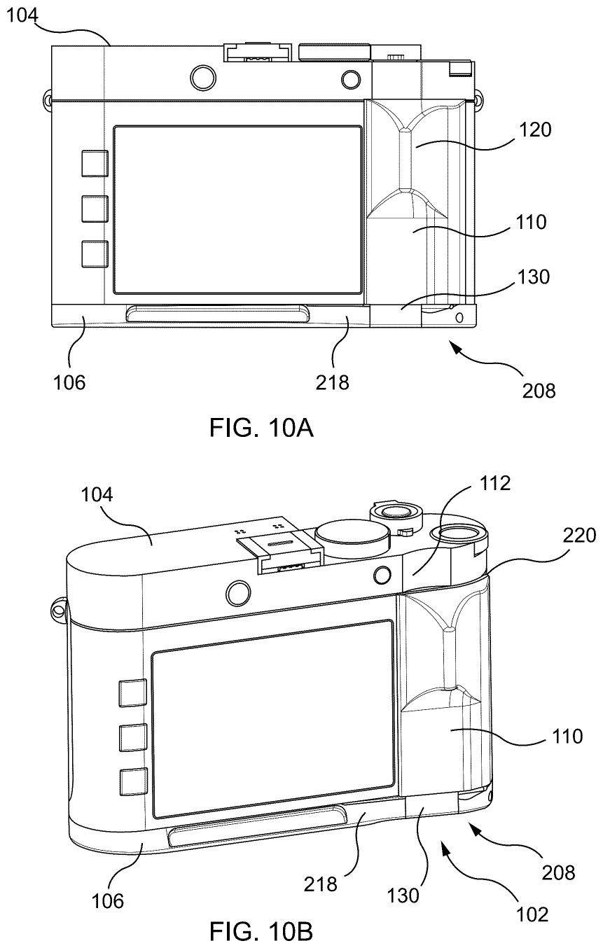

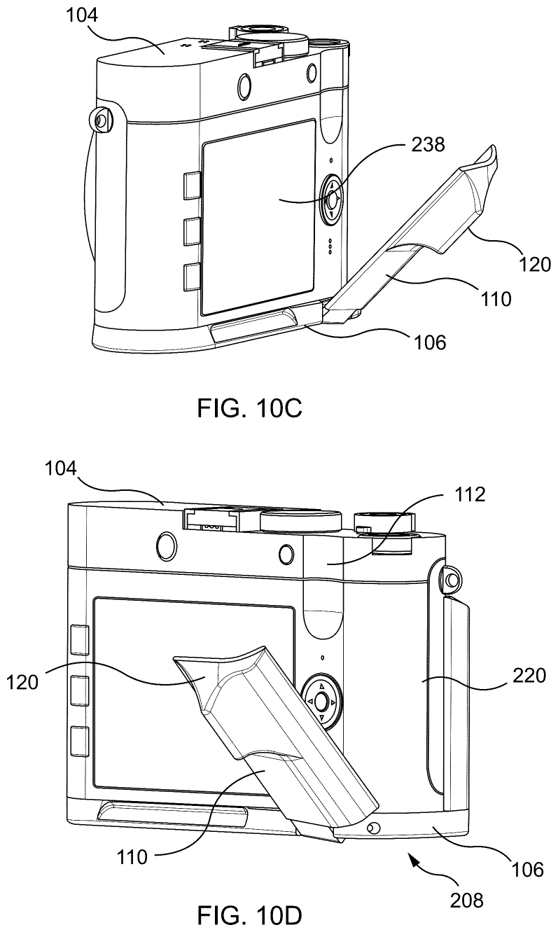

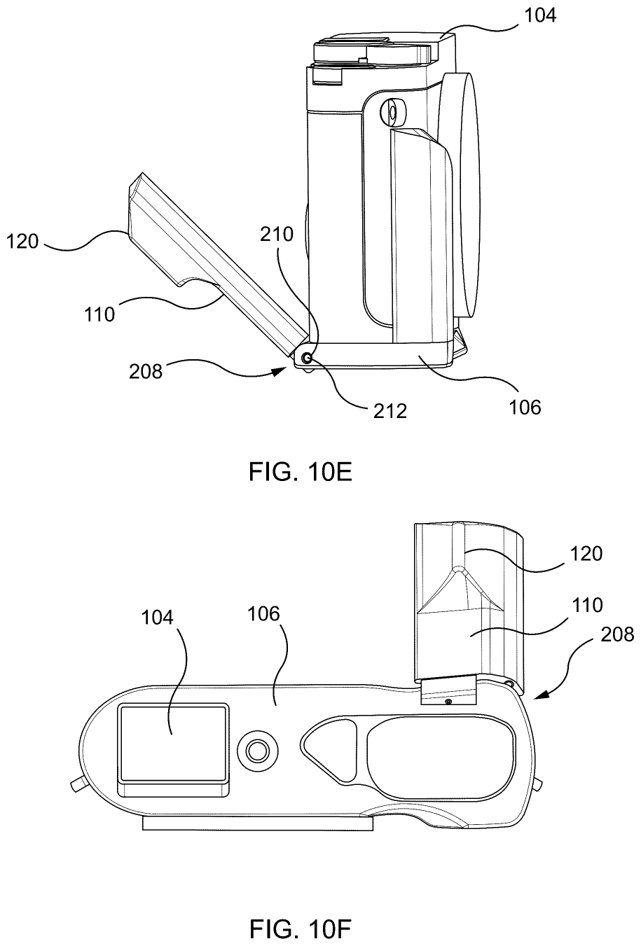

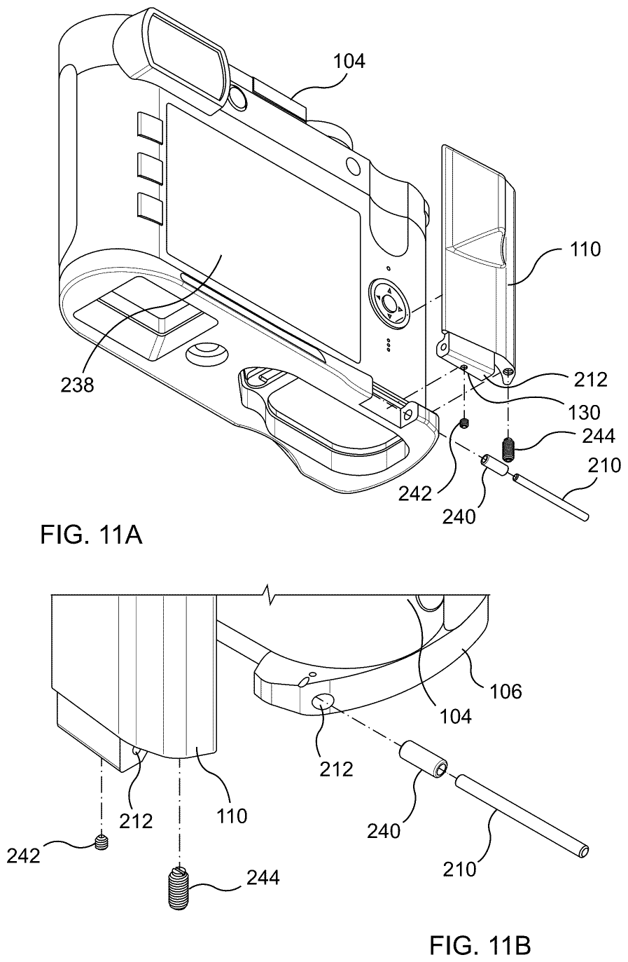

Referring to the drawings, particularly FIGS. 10A to 10F, 11A and 11B an embodiment of the camera handgrip assembly 102 is illustrated, wherein the palm grip 110 and thumb anchor 120 are integrally formed as a unit and are pivotally attached to the base plate 106 by a hinge mechanism 208. The hinge mechanism 208 is located at the lower portion 130 of the palm grip and enables the palm grip 110 with thumb anchor 120 assembly to pivot outwardly from its position adjacent the rear surface or back portion 112 of the camera 104.

In this embodiment, the hinge mechanism 208 comprises a pin 210 that passes through aligned openings 212 in the base plate 106 and corresponding openings in the lower portion 130 of the palm grip 110. The pin 210 may be constructed from metal or other suitable materials and is sized to provide an interference fit with the palm grip and sliding fit with the base plate, thereby ensuring secure and smooth pivotal movement of the palm grip with thumb anchor assembly relative to the base plate 106. Alternatively, the hinge mechanism may include bushings or bearings positioned within the openings to facilitate smooth rotation and reduce wear during repeated use. In further embodiments, the hinge may be implemented using alternative mechanisms, such as a living hinge, a flexible joint, or other suitable pivoting structures, as appropriate for the intended application.

When the palm grip 110 and thumb anchor 120 assembly is in the closed position, the lower portion 130 of the palm grip arm forms a continuous surface with the outer wall 218 of the base plate 106, providing a seamless and unobtrusive interface. This configuration maintains the streamlined profile of the camera handgrip assembly 102 and ensures that the grip does not interfere with the overall aesthetics or functionality of the camera 104.

The palm grip 110 and thumb anchor 120 are further configured to follow the contour of the body of camera 104 and, in certain embodiments, may partially extend around the rear wall or surface 112 and side wall portions 220 of the camera 104, as shown in FIGS. 10B and 10D. This arrangement enhances ergonomic support and stability for the user while allowing the palm grip 110 and thumb anchor 120 assembly to be pivoted outwardly to facilitate access to camera features that may otherwise be obstructed by the grip assembly.

Turning now to FIGS. 11A and 11B, exploded perspective full and partial views are provided, looking upward and downward, respectively, to further illustrate the assembly of the palm grip 110 relative to the base plate 106 and the camera 104. In these views, the palm grip 110 is shown with a flange at its lower or bottom portion 130 having a circular opening 212 through which the hinge pin 210 passes. The hinge pin 210 also passes through corresponding openings 212 in the base plate 106. A bushing 240 is positioned within the opening in the base plate 106 to receive the hinge pin 210, enhancing the durability and smoothness of the pivoting action. A set screw 242 is configured to secure the pin 210 in place within the flange at the bottom portion 130 of palm grip and thumb anchor assembly, to keep the pin from rotating and easy removal for maintenance. Additionally, a spring-loaded detent pin or ball plunger 244 is provided, oriented at a 90-degree angle relative to the hinge pin 210, to prevent the hinge pin 210 from unintentionally sliding out of position during use.

The exploded views of FIGS. 11A and 11B further illustrate how the palm grip 110, when pivoted to the upright position, covers the user interface components 117 of the camera 104, such as a button or control located on the rear surface or back portion 112. However, other interface components, including the LCD screen 238, remain accessible to the user. This configuration allows the palm grip 110 and thumb anchor 120 assembly to be positioned for optimal ergonomic support during photography, while also enabling the user to pivot the assembly outwardly to access camera controls as needed. Additionally, having the palm grip with thumb anchor assembly right on top of the rear buttons and dial, prevent inadvertent activation of these controls during use i.e. taking pictures or recording videos.

This integrated hinge mechanism and assembly, as shown in FIGS. 10A to 10F and FIGS. 11A and 11B, provides both ergonomic flexibility and practical access to camera controls, contributing to the overall utility and versatility of the camera handgrip assembly 102.

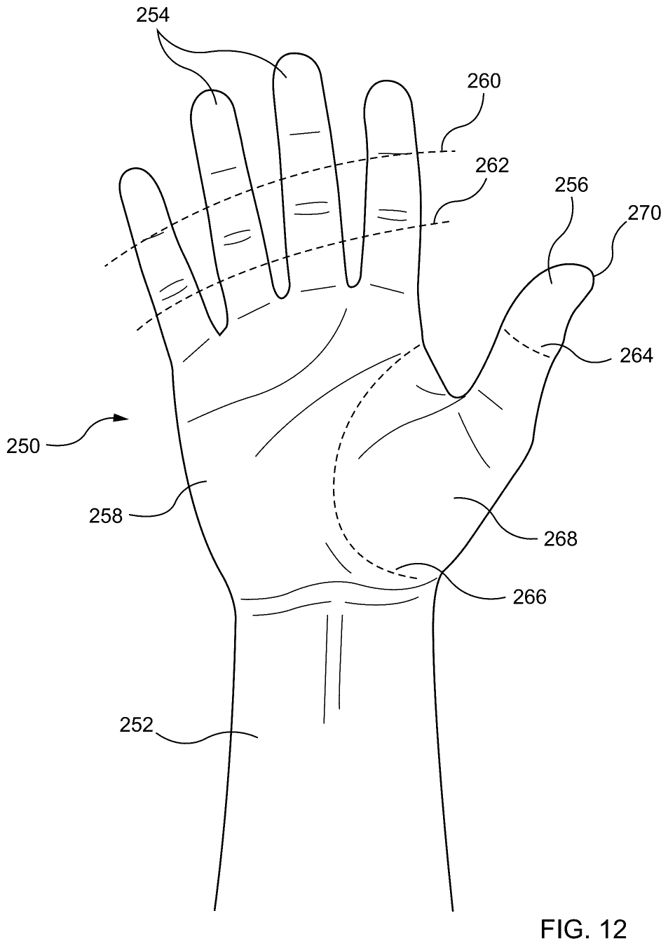

To further illustrate the ergonomic considerations and anatomical features referenced herein, FIG. 12, shows an anatomical diagram of a human hand 250, shown from the palmar (inner) side and partially connected to a forearm 252. The hand 250 is depicted with individual fingers 254, a thumb 256, and the palm region 258. The illustration is provided to clarify the ergonomic considerations underlying the design of the camera handgrip assembly, particularly the palm grip, as discussed in the claims and throughout the specification.

Two broken lines 260 and 262 are shown traversing the fingers 254 in a generally transverse direction. These lines indicate the typical regions of contact between the user's fingers 254 and the front portion of the camera or the front grip 140 when the camera is held in a shooting position. The placement of these lines demonstrates how the ergonomic recess and finger grip are configured to support the user's fingers for improved comfort and control. In embodiments where there this no front grip, the fingers 254 grip the front surface of the camera 104.

On the palm 258, two additional broken lines 264 and 266 are depicted, extending in a generally curved fashion to define the anatomical region known as the thenar eminence 268. The thenar eminence 268 is the fleshy, muscular area at the base of the thumb 256, and is a critical region for ergonomic support. The palm grip 110 of the camera handgrip assembly 104 is specifically shaped and positioned to engage and support the thenar eminence 268, thereby reducing hand fatigue and enhancing stability during prolonged camera use.

The tip of the thumb 270 is also indicated, showing its natural position relative to the thenar eminence 268 and the palm 258. This further illustrates the importance of the thumb anchor 120, which is designed to provide a secure anchoring point for the thumb 256, complementing the support provided to the thenar eminence 268 by the palm grip 110.

The depiction in FIG. 12 is intended to supplement the discussion of hand anatomy and ergonomic function found in the claims and detailed description. By illustrating the specific regions of the hand that interact with the camera handgrip assembly, FIG. 12 emphasizes the importance of the palm grip 110 in providing targeted support to the thenar eminence 268, as well as the role of the front grip 140 and thumb anchor 120 in facilitating a secure and comfortable grip.

The materials and manufacturing methods for the hinged palm grip 110 and thumb anchor 120 assembly may be selected from those described in other embodiments, including metal alloys, polymers, or additive manufacturing techniques such as 3D printing. The hinge feature provides both ergonomic flexibility and practical access to camera controls, contributing to the overall utility and versatility of the camera handgrip assembly 102.

The base plate, palm grip with thumb anchor and front grip may be made from lightweight and durable materials such as, for example, aluminium, brass and magnesium alloy. For mass production palm grip with thumb support and front (fingers) grip can be manufactured by injection molding a plastic/polymer or insert molding some soft polymer onto a metal insert where metal portion has the mounting features for strength and polymer portion has gripping features. In addition, due to the wide variety of specialty cameras on the market, each with unique dimensions and requirements, it may not be practical to produce dedicated molds for every handgrip assembly. Accordingly, it is contemplated that these handgrip assemblies, including the base plate, palm grip, thumb anchor, and front grip, may be manufactured using additive manufacturing techniques such as 3D printing. This approach enables rapid customization and production of handgrip assemblies tailored to specific camera models, even in low volumes as requested by camera enthusiasts. 3D printing technologies, including selective laser melting (SLM) and direct metal laser sintering (DMLS), are capable of producing components in metals such as aluminum, which is suitable for lightweight and durable camera accessories. This method allows for efficient, on-demand manufacturing without the need for costly tooling or molds, thereby supporting the creation of bespoke ergonomic solutions for a diverse range of cameras.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

What is claimed is:

1. A camera handgrip assembly comprising:
a base plate having a shape that conforms with a bottom portion of a camera, the base plate configured to be removably affixed with the bottom portion of the camera;
a palm grip extending upwardly from the base plate and configured to be positioned adjacent a back portion of the camera towards one side of the camera when the base plate is affixed to the camera allowing access to user interface components of the camera and providing a palm supporting surface; and
a thumb anchor configured to project above the palm grip and outwardly of the back portion of the camera to anchor a thumb for enhancing stability and control of the camera.

2. The camera handgrip assembly of claim 1, wherein the palm grip has a smooth ergonomical surface for supporting a thenar eminence of the palm when holding the camera to thereby reduce hand fatigue and discomfort during prolonged use.

3. The camera handgrip assembly of claim 1, wherein the thumb anchor is integrally formed with the palm grip.

4. The camera handgrip assembly of claim 1, wherein the thumb anchor is detachably attached with the palm grip.

5. The camera handgrip assembly of claim 3, wherein:
the palm grip with the thumb anchor shares an inner profile and an outer profile;
the inner profile partially surrounds the back portion and the one side of the camera and conforms to the shape of the camera with at least the palm grip partially surrounding the camera in a secure and manageable fitting relation; and,
the outer profile has smooth curving lower portion of the palm grip for supporting a palm, the lower portion of the outer profile of the palm grip having a flush continuous profile with the base plate providing a smooth interface between the base plate and lower portion of the palm grip, a middle portion of the palm grip above the lower portion curving outwardly relative to the back portion of camera into the thumb anchor.

6. The camera handgrip assembly of claim 4, wherein the thumb anchor is configured with opposing side portions that narrow the thumb anchor to a tip portion as it projects away from the back portion of the camera and wherein at least one of the opposing side portions has a concave curvature.

7. The camera handgrip assembly of claim 1, wherein the base plate comprises a first locating pocket having at least one first aperture passing therethrough, the palm grip having a palm grip bottom portion that abuts the first locating pocket and the palm grip bottom portion having at least one recessed threaded bore extending into the palm grip bottom portion that align with the at least one first aperture passing through the first locating pocket, and wherein at least one threaded fastener passes through the at least one first aperture and is screwed into the recessed threaded bore of the palm grip bottom portion securing the palm grip with the base plate.

8. The camera handgrip assembly of claim 1, comprising a front grip extending upwardly from the base plate and configured to be positioned adjacent a front portion of the camera towards the one side of the camera when the base plate is affixed to the camera providing a finger supporting surface.

9. The camera handgrip assembly of claim 8, wherein:
the front grip has a front grip inner profile and a front grip outer profile, the front grip inner profile partially surrounding the front portion and the one side of the camera and conforms to the shape of the camera; and,
the front grip partially surrounding the camera in a secure and manageable fitting relation; and,
the front grip outer profile has smooth convex curvature for supporting fingers, the front grip outer profile having a front grip lower portion located flush and continuous with the base plate providing a smooth interface between the base plate and front grip lower portion.

10. The camera handgrip assembly of claim 8, further wherein the base plate comprises a second locating pocket with at least one second aperture passing therethrough, the front grip having a front grip bottom portion that abuts the second locating pocket and the front grip bottom portion having at least one second recessed threaded bore extending into the front grip bottom portion that align with the at least one second aperture passing through the second locating pocket, and wherein at least one threaded fastener passes through the at least one second aperture and is screwed into the at least one second recessed bore of the front grip bottom portion securing the front grip with the base plate.

11. The camera handgrip assembly of claim 1, wherein the base plate comprises an ergonomic recess located in a front of the base plate to the one side of the camera when the camera is affixed to the base plate.

12. The camera handgrip assembly of claim 11, wherein the ergonomic recess is sized to allow a finger to slip under the base plate, the ergonomic recess having rounded edges to provide a smooth surface.

13. The camera handgrip assembly of claim 11, wherein the ergonomic recess comprises a relief cut in the base plate configured to accommodate various hand sizes and provide a smooth pinky finger supporting surface.

14. The camera handgrip assembly of claim 11, wherein the ergonomic recess has a curved and concave profile.

15. The camera handgrip assembly of claim 11, wherein the ergonomic recess is located on a front surface of the base plate and extends partially onto the bottom surface of the base plate.

16. The camera handgrip assembly of claim 1, wherein:
the base plate has a front wall and a back wall, each of the front wall and back wall having a top wall portion and a bottom wall portion where the bottom wall portion is tapered outwardly in relation to the top wall portion and the bottom wall portion is thicker than the top wall portion; and,
a mounting cavity is recessed in each of the front and the back walls comprising a dual bevel configuration with a bottom surface and a top surface sloping towards each other and inwardly of the corresponding front or back wall.

17. The camera handgrip assembly of claim 1, wherein the palm grip with the thumb anchor are integrally formed as a unit and are hinged at a lower portion to the base plate whereby the palm grip with thumb anchor assembly is configured to pivot outwardly from its position adjacent the rear surface of the camera to facilitate access to camera features that would otherwise be obstructed by the palm grip and thumb anchor.

18. The camera handgrip assembly of claim 17, wherein the hinge comprises a pin passing through aligned openings in the base plate and the lower portion of the palm grip.

19. The camera handgrip assembly of claim 17, wherein the lower portion of the palm grip forms a continuous surface with the outer wall of the base plate when in a closed position, and wherein when in the closed position, the palm grip and the thumb anchor are positioned adjacent to, but slightly spaced from, the camera rear wall, thereby preventing inadvertent activation of camera controls located on or near the rear wall.

20. The camera handgrip assembly of claim 17, wherein the hinge includes bushings, bearings, a living hinge, or other suitable mechanisms to facilitate smooth pivoting of the palm grip and thumb anchor assembly relative to the base plate.
